(19) United States
(12) Patent Application Publication
(10) Pub. No.: US 2016/0223228 A1
(43) Pub. Date: Aug. 4, 2016

(54) REGENERATOR AND STIRLING CRYOCOOLER

(71) Applicant: SUMITOMO HEAVY INDUSTRIES, LTD., Tokyo (JP)

(72) Inventors: Kyosuke NAKANO, Nishitokyo-shi (JP); Yoshikatsu HIRATSUKA, Nishitokyo-shi (JP); Kenta YUMOTO, Nishitokyo-shi (JP)

(73) Assignee: SUMITOMO HEAVY INDUSTRIES, LTD.

(21) Appl. No.: 15/005,902

(22) Filed: Jan. 25, 2016

(30) Foreign Application Priority Data
Jan. 29, 2015 (JP) 2015-015234

(51) Int. Cl. F25B 9/14; F02G 1/057

(52) U.S. Cl. CPC F25B 9/14; F02G 1/057; F25B 2309/1428

(57) ABSTRACT

A regenerator includes an axially extending regenerator-element container, and a regenerator-element laminated structure accommodated in the regenerator-element container. The regenerator-element laminated structure comprises a plurality of first regenerator-element members axially stacked in layers, and each extending along a plane perpendicular to the axis of regenerator extension. The plurality of first regenerator-element members each comprise an outer rim portion and/or an inner rim portion extending in a direction not lying in said plane, such as to fill a gap between the regenerator-element container and the regenerator-element laminated structure.

### RELATED APPLICATIONS

Priority is claimed to Japanese Patent Application No. 2015-015234, filed Jan. 29, 2015, the entire content of which is incorporated herein by reference.

### BACKGROUND

1. Technical Field

Certain embodiments of the invention relate to a regenerator and a Stirling cryocooler.

2. Description of Related Art

For the regenerator elements in cryogenic refrigerators such as Stirling cryocoolers, a plurality of laminated wire-mesh sheets are sometimes used. The regenerator elements are packed into a container, which is then fitted into the refrigerator.

### SUMMARY

According to an aspect of the present invention, there is provided a regenerator including an axially extending regenerator-element container, and a regenerator-element laminated structure accommodated in the regenerator-element container. The regenerator-element laminated structure includes a plurality of first regenerator-element members axially stacked in layers, and each extending along a plane perpendicular to the axis of regenerator extension. The plurality of first regenerator-element members each include a rim portion extending in a direction not lying in said plane, such as to fill a gap between the regenerator-element container and the regenerator-element laminated structure.

According to another aspect of the present invention, there is provided a Stirling cryocooler, furnished with: an axially extending displacer; and a regenerator arranged surrounding the displacer such as to guide axially reciprocating travel of the displacer. The regenerator includes a container inner cylinder extending axially and guiding the reciprocating travel of the displacer, a container outer cylinder extending axially and forming an accommodation space between the container inner and outer cylinders, and a regenerator-element laminated structure accommodated in the accommodation space. The regenerator-element laminated structure include a plurality of first regenerator-element members axially stacked in layers, and each extending along a plane perpendicular to the axis of regenerator extension. The plurality of first regenerator-element members each include an inner rim portion extending in a direction not lying in said plane, and an outer rim portion extending in a direction not lying in said plane, such as to fill an inner gap between the container inner cylinder and the regenerator-element laminated structure, and such as to fill an outer clearance between the container outer cylinder and the regenerator-element laminated structure.

### BRIEF DESCRIPTION OF THE DRAWINGS

FIG. 1 is a view schematically showing a Stirling cryocooler according to a first embodiment of the present invention.

FIG. 2 is a view schematically showing an expander according to the first embodiment of the present invention.

FIG. 3 is a sectional view schematically showing a regenerator of a Stirling cryocooler.

FIG. 4 is a sectional view schematically showing a regenerator according to the first embodiment of the present invention.

FIG. 5 is a top view schematically showing a regenerator material member of the regenerator according to the first embodiment of the present invention.

FIG. 6 is a sectional view schematically showing a regenerator according to a second embodiment of the present invention.

FIG. 7 is a sectional view schematically showing a regenerator according to a third embodiment of the present invention.

FIG. 8 is a sectional view schematically showing a regenerator according to a fourth embodiment of the present invention.

### DETAILED DESCRIPTION

Due to a manufacturing tolerance, a slight gap may occur between regenerator materials and a vessel. The gap may be a passage of working gas. If the working gas flows to the gap, heat exchange between the regenerator materials and the working gas is not effectively performed. Accordingly, efficiency of a regenerator decreases.

It is desirable to decrease the gap between the regenerator materials and the vessel in the regenerator of a cryocooler.

In addition, certain embodiments of the invention include arbitrary combination of the above-described components, or components or expressions of the present invention which are replaced to each other between methods, devices, systems, or the like.

According to certain embodiment of the invention, it is possible to decrease a gap between a regenerator material and a vessel in a regenerator in a cryocooler.

It should be understood that the invention is not limited to the above-described embodiment, but may be modified into various forms on the basis of the spirit of the invention. Additionally, the modifications are included in the scope of the invention.

Hereinafter, certain embodiments of the invention will be described in detail with reference to the drawings. In addition, in descriptions thereof, the same reference numerals are assigned to the same elements, and overlapping descriptions are appropriately omitted. In addition, configurations described below are exemplified, and do not limit a scope of the present invention.

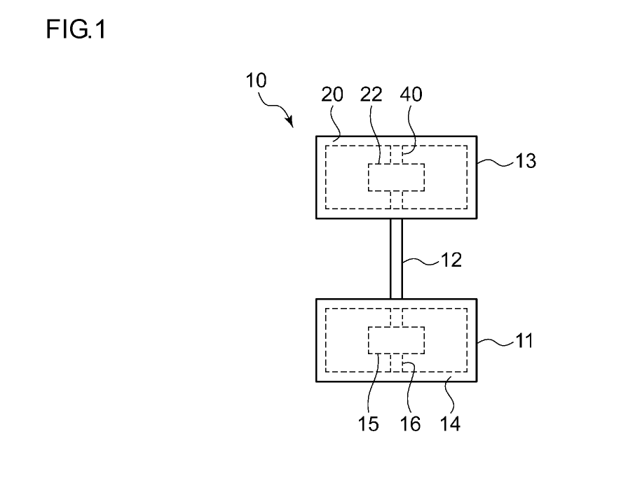

FIG. 1 is a view schematically showing a Stirling cryocooler 10 according to a first embodiment of the present invention. The Stirling cryocooler 10 includes a compressor 11, a connection pipe 12, and an expander 13.

The compressor 11 includes a compressor case 14. The compressor case 14 is a pressure vessel which is configured so as to airtightly hold a high-pressure working gas. For example, the working gas is helium gas. In addition, the compressor 11 includes a compressor unit which is accommodated in the compressor case 14. The compressor unit includes a compressor piston and a compressor cylinder, one of the compressor piston and the compressor cylinder is a movable member 15 which is configured so as to reciprocate in the compressor case 14, and the other is a stationary member which is fixed to the compressor case 14. The compressor unit includes a drive source for driving the movable member 15 with respect to the compressor case 14 in a direction along the center axis of the movable member 15. The compressor 11 includes a support portion 16 which supports movable member 15 to the compressor case 14 such that the movable member 15 can reciprocate. The movable member 15 is vibrated with respect to the compressor case 14 and the stationary member at certain amplitude and a frequency. As a result, a pressure of the working gas inside the compressor 11 is changed at specific amplitude and a specific frequency.

A working gas chamber is formed between the compressor piston and the compressor cylinder. The working gas chamber is connected to one end of the connection pipe 12 via communication passages which are formed in the above-described stationary member and the compressor case 14. The other end of the connection pipe 12 is a working gas chamber of the expander 13. Accordingly, the working gas chamber of the compressor 11 and the working gas chamber of the expander 13 are connected to each other by the connection pipe 12.

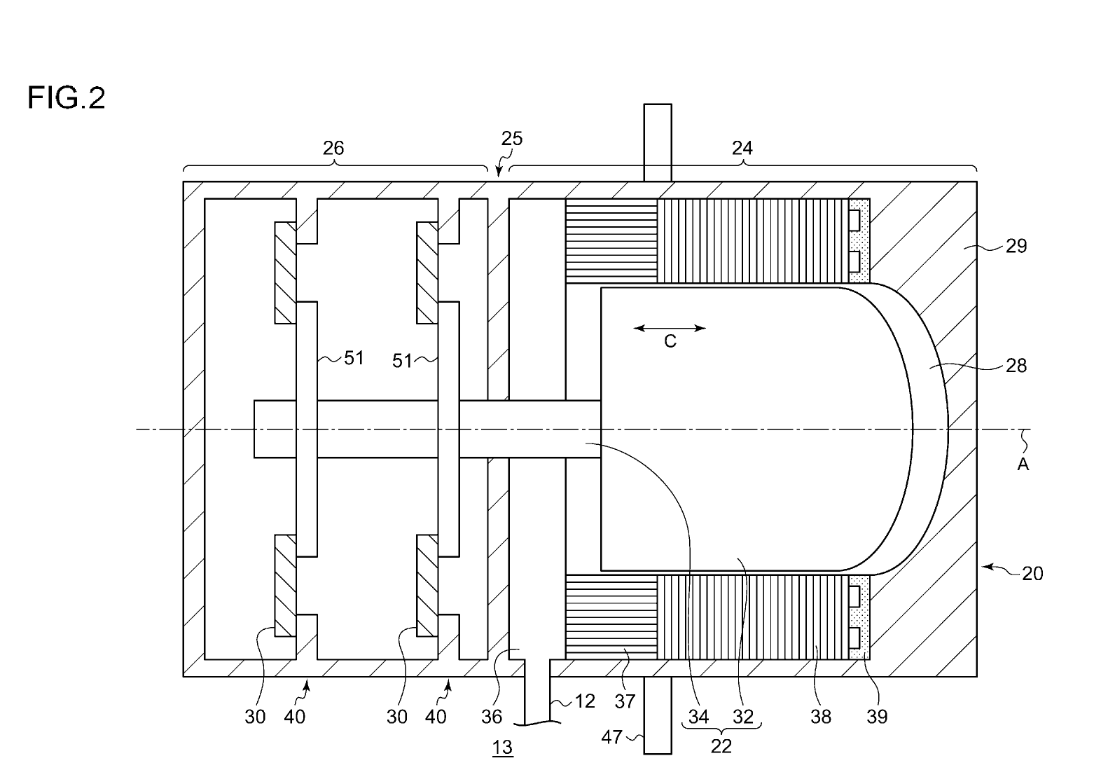

As described below with reference to FIG. 2, the expander 13 includes an expander main body 20, a displacer 22, and at least one support portion 40.

FIG. 2 is a view schematically showing the expander 13 according to the first embodiment of the present invention. FIG. 2 schematically shows an inner structure of the expander 13.

The expander main body 20 is a pressure vessel which is configured so as to airtightly hold a high-pressure working gas. The pressure vessel may be configured of a plurality of vessel portions which are connected to each other so as to airtightly hold the inner portion of the pressure vessel. The displacer 22 is a movable member which is configured so as to reciprocate in the expander main body 20. The support portion 40 supports the displacer 22 to the expander main body 20 such that the displacer 22 can reciprocate.

The expander main body 20 includes a first section 24 and a second section 26. The first section 24 is an expansion space 28 of working gas which is formed between the expander main body 20 and the displacer 22. A cooling stage 29 for cooling an object is provided on the portion of the expander main body 20 adjacent to the expansion space 28. The second section 26 is configured so as to support the displacer 22 to the expander main body 20 via elastic members 30.

In the expander main body 20, a portion of the first section 24 side is accommodated in a vacuum vessel (not shown). A vacuum layer inside the vacuum vessel and an atmospheric layer outside the vacuum vessel are separated from each other by a flange 47.

The second section 26 is adjacent to the first section 24 in a reciprocation direction (shown by arrow C in FIG. 1) of the displacer 22. A seal portion 25 is provided between first section 24 and the second section 26. Accordingly, the second section 26 is partitioned from the first section 24. Accordingly, pressure variation of the working gas in the first section 24 is not transmitted to the second section 26, or does not substantially influence the pressure of the working gas in the second section 26. In addition, the same kind of gas as the working gas is sealed in the second section 26 such that the second section 26 has the same pressure as an average pressure of the working gas fed from the compressor 11.

The displacer 22 includes a displacer head 32 which is accommodated in the first section 24, and a displacer rod 34. The displacer rod 34 is a shaft portion which is thinner than the displacer head 32. The displacer 22 has a center axis (shown by a chain line A in FIG. 1) which is parallel to the reciprocation direction, and the displacer head 32 and the displacer rod 34 are coaxially provided in the center axis of the displacer 22. The displacer 22 is an inner space, and the inner space is filled with the same kind of gas as the working gas.

The displacer rod 34 extends from the displacer head 32 to the second section 26 via the seal portion 25. The displacer rod 34 is supported by the expander main body 20 in the second section 26 such that the displacer 22 can reciprocate. For example, the above-described seal portion 25 may be a rod seal which is formed between the displacer rod 34 and the expander main body 20. In addition, similarly to the displacer head 32, the displacer rod 34 also has an inner space. The displacer rod 34 is connected to the displacer head 32, and communicates with the inner spacer of the displacer head 32.

The first section 24 forms a cylinder portion which surrounds the displacer head 32. The expansion space 28 is formed between a bottom surface of the cylinder portion and a tip surface of the displacer head 32. The expansion space 28 is formed on a side opposite to a joining portion between the displacer head 32 and the displacer rod 34 in the reciprocation direction of the displacer 22. A gas space 36 which is connected to the connection pipe 12 is formed between the joining portion and the seal portion 25.

A regenerator 38 is attached to the side surface of the cylinder portion of the expander main body 20 so as to be positioned on the outer circumferential portion of the displacer head 32. More specifically, the regenerator 38 is provided on the side surface of the cylinder portion of the expander main body 20 so as to be positioned at a cylindrical region which has a longitudinal axis of the displacer 22 as the center axis in the outer circumferential portion of the displacer head 32. For example, the regenerator 38 has a laminated structure of wire meshes. The flow of the working gas between the expansion space 28 and the gas space 36 can be performed through the regenerator 38.

A water cooling type heat exchanger 37 can be provided between the regenerator 38 and the gas space 36. The water cooling type heat exchanger 37 cools the working gas supplied from the compressor 11 and realizes heat exchange for discharging the heat from working gas to the outside of the expander 13. In addition, a low-temperature heat exchanger 39 is attached to a portion between the regenerator 38 and the cooling stage 29.

In the expander 13, expander main body 20 supports the displacer 22 at a plurality of different positions in the reciprocation direction of the displacer 22 such that the displacer 22 can reciprocate. Accordingly, the expander 13 includes two support portions 40. The two support portions 40 are provided in the second section 26. Therefore, it is possible to prevent tilting of the displacer 22 with respect to the center axis.

The support portion 40 includes the above-described elastic member 30. The elastic member 30 is disposed between the displacer rod 34 and the expander main body 20 such that an elastic restoring force is applied to the displacer 22 when the displacer 22 is displaced from a neutral position. Accordingly, the displacer 22 reciprocates at a natural frequency which is determined from an elastic coefficient of the elastic member 30, an elastic coefficient due to the pressure of the working gas, and weight of the displacer 22.

For example, the elastic member 30 has a spring mechanism which includes at least one plate spring. The plate spring is a spring referred to as a flexure spring, and the plate spring is flexible in the reciprocation direction of the displacer 22 and is rigid in a direction perpendicular to the reciprocation direction. Therefore, the movement of the displacer 22 along the direction along the center axis is allowed by the elastic member 30. However, the movement of the displacer 22 in the direction orthogonal to the center axis is regulated by the elastic member 30. The displacer rod 34 is fixed to the elastic member 30 via an elastic member attachment portion 51.

In this way, a vibration system including the displacer 22 and the elastic member 30 is configured. The vibration system is configured such that the displacer 22 is vibrated so as to have the vibration and the phase difference at the same frequency as the vibration of the movable member 15 of the compressor 11. The displacer 22 is driven by pulsation of a working gas pressure generated by the vibration of the movable member 15 of the compressor 11. A reverse Stirling cycle is formed between the expansion space 28 and the working gas chamber of the compressor 11 by reciprocation of the displacer 22 and the movable member 15 of the compressor 11. Accordingly, the cooling stage adjacent to the expansion space 28 is cooled, and it is possible to cool an object by the Stirling cryocooler 10.

Subsequently, a regenerator material lamination structure of the Stirling cryocooler 10 according the first embodiment will be described.

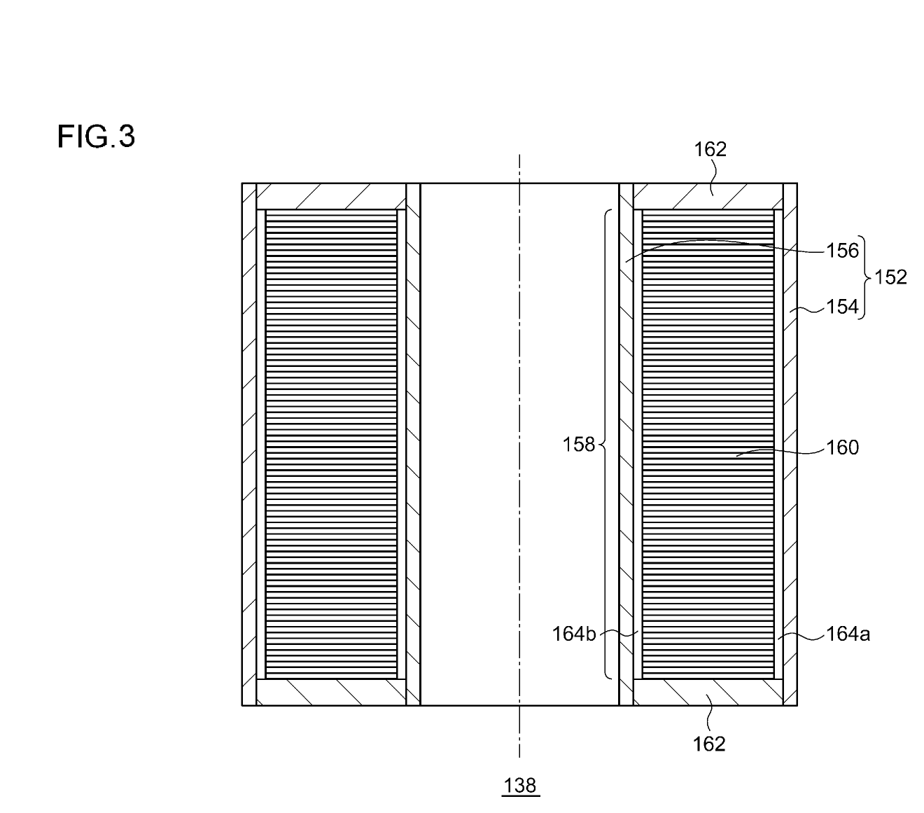

FIG. 3 is a sectional view schematically showing a regenerator 138 of a Stirling cryocooler. In FIG. 3, the displacer is not shown, and the center axis is shown by a chain line. The regenerator 138 is disposed so as to be coaxial with the center axis of the displacer.

The regenerator 138 includes a regenerator material vessel 152 which has a vessel outer cylinder 154 and a vessel inner cylinder 156. The vessel inner cylinder 156 functions as a cylinder which guides the displacer. A regenerator material laminated body 158 is accommodated between the vessel outer cylinder 154 and the vessel inner cylinder 156. The regenerator material laminated body 158 is formed of a plurality of wire mesh members 160 which are laminated in the axial direction. Each of the wire mesh member 160 extends along a plane perpendicular to the axial direction. A pair of holders 162 is provided on both ends of the regenerator material laminated body 158 in the axial direction. The wire mesh member 160 has an annular shape or a doughnut shape. Similarly, the holder 162 also has an annular shape or a doughnut shape.

In general, the wire mesh members 160 are completely embedded to a space inside the regenerator material vessel 152, and the sizes of the wire mesh members 160 are determined such that a gap is not generated between the regenerator material vessel 152 and the regenerator material laminated body 158. However, in actual, as shown in the drawing, a slight gap is generated between the regenerator material laminated body 158 and the regenerator material vessel 152. An outer gap 164a is generated between the vessel outer cylinder 154 and the regenerator material laminated body 158, and an inner gap 164b is generated between the vessel inner cylinder 156 and the regenerator material laminated body 158. The gap is generated due to the manufacturing tolerance of the wire mesh member 160. The gap may be a passage of the working gas. If the working gas flows along the gap, heat exchange between the working gas and the regenerator material is not effectively performed. Accordingly, efficiency of the regenerator 138 decreases. Even when a slight gap is generated, performance of the regenerator 138 significantly decreases.

Accordingly, the regenerator 38 according to the first embodiment is configured so as to decrease or completely remove the gap between the regenerator material and the vessel.

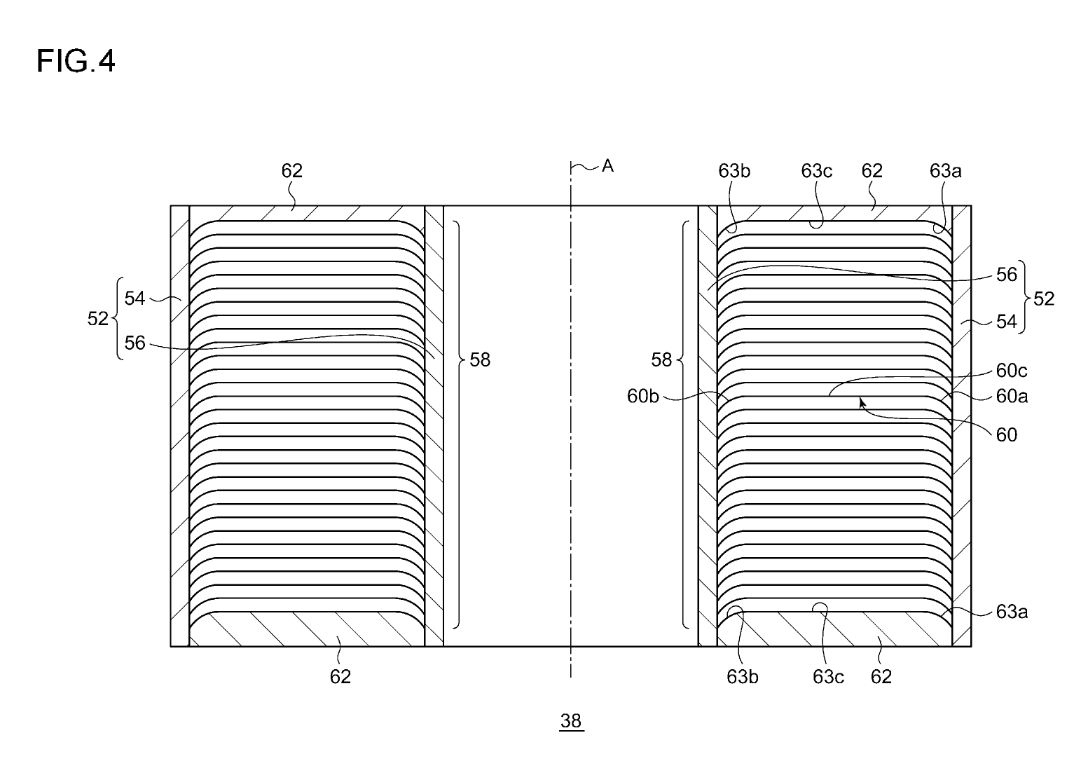

FIG. 4 is a sectional view schematically showing the regenerator 38 according to the first embodiment of the present invention. In FIG. 4, the displacer 22 shown in FIG. 2 is not shown, and similarly to FIG. 2, the center axis of the displacer 22 is shown by the chain line A. The displacer 22 extends in the axial direction. The regenerator 38 is disposed so as to be coaxial with the center axis of the displacer 22. The regenerator 38 is disposed around the displacer 22 so as to guide the reciprocation of the displacer 22 in the axial direction. The upper portion in FIG. 4 is a low temperature portion of the Stirling cryocooler 10, and the lower portion is a normal temperature portion. Accordingly, the expansion space 28 shown in FIG. 2 is formed above the regenerator 38 in FIG. 2.

The regenerator 38 includes a regenerator material vessel 52, and a regenerator material laminated body 58 which is accommodated in the regenerator material vessel 52. The regenerator material vessel 52 is an annular or a doughnut-shaped vessel which includes a vessel outer cylinder 54 and a vessel inner cylinder 56. The vessel outer cylinder 54 extends in the axial direction, and forms an accommodation space of the regenerator material laminated body 58 between the vessel inner cylinder 56 and the vessel outer cylinder 54. The vessel inner cylinder 56 extends in the axial direction, and functions as a cylinder portion which guides the reciprocation of the displacer 22.

The regenerator material laminated body 58 is formed of a plurality of regenerator material members 60 which are laminated in the axial direction. Each of the regenerator material members 60 extends along a plane perpendicular to the axial direction. The regenerator material member 60 is a wire mesh member having an annular shape or a doughnut shape.

A pair of holders 62 is provided on both ends of the regenerator material laminated body 58 in the axial direction. One holder 62 is disposed on the low temperature portion, and the other holder 62 is disposed on the normal temperature portion. Similarly to the regenerator material member 60, the holder 62 also has an annular shape or a doughnut shape. The pair of holder 62 clamps the regenerator material laminated body 58 from both ends in the axial direction so as to compress and hold the regenerator material laminated body 58 in the axial direction. The reason of compressing and holding the regenerator material is to prevent a positional variation of the regenerator material due to a flow of the working gas. In this way, the plurality of regenerator material members 60 which form the regenerator material laminated body 58 are fixed between the pair of holder 62.

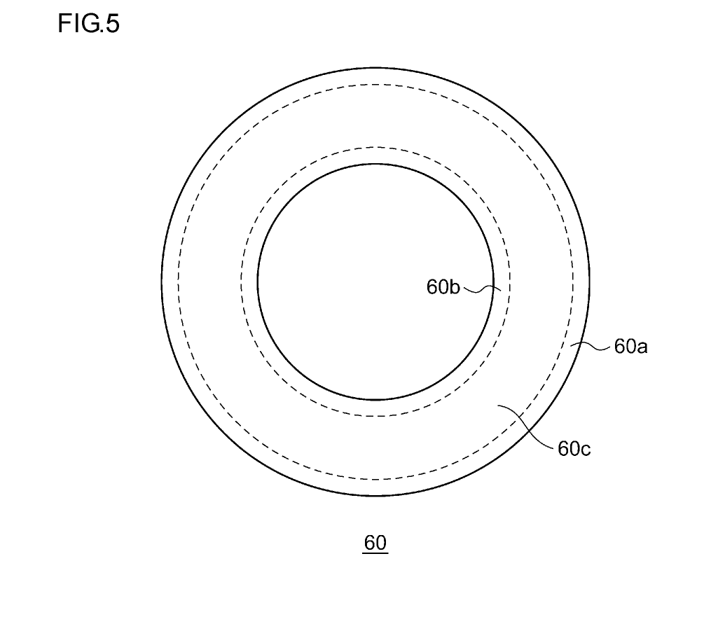

FIG. 5 is a top view schematically showing the regenerator material member 60 of the regenerator 38 according to the first embodiment of the present invention. Each of the regenerator material members 60 includes an outer rim portion 60a and an inner rim portion 60b. The outer rim portion 60a is formed on the outer circumference of the regenerator material member 60, and the inner rim portion 60b is formed on the inner circumference of the regenerator material member 60. The regenerator material member 60 includes a center flat portion 60c between the outer rim portion 60a and the inner rim portion 60b.

The center flat portion 60c is annular region which occupies most of the wire mesh member which is the regenerator material member 60, and extends along a plane perpendicular to the axial direction. The outer rim portion 60a is a ring-shaped portion which extends toward the outside in the radial direction from the center flat portion 60c, and forms a portion of the wire mesh member. The inner rim portion 60b is a ring-shaped portion which extends toward the inside in the radial direction from the center flat portion 60c, and forms a portion of the wire mesh member. In FIG. 5, a boundary line between the outer rim portion 60a and the center flat portion 60c is shown by a broken line. In addition, a boundary line between the inner rim portion 60b and the center flat portion 60c is shown by a broken line.

As shown in FIG. 4, each of the outer rim portions 60a and the inner rim portions 60b is formed in a curved shape (for example, a round shape or a tapered shape). The outer rim portion 60a extends from the center flat portion 60c in a direction (for example, axial direction) other than the direction of the plane perpendicular to the axial direction. The outer rim portion 60a comes into contact with the vessel outer cylinder 54. Accordingly, an outer gap which is generated between the vessel outer cylinder 54 and the regenerator material laminated body 58 is filled with the outer rim portions 60a. Similarly, the inner rim portion 60b extends from the center flat portion 60c in a direction (for example, axial direction) other than the direction of the plane perpendicular to the axial direction. The inner rim portion 60b comes into contact with the vessel inner cylinder 56. Accordingly, an inner gap which is generated between the vessel inner cylinder 56 and the regenerator material laminated body 58 is filled with the inner rim portions 60b.

The size of outer rim portion 60a and/or the inner rim portion 60b may be significantly smaller than the size of the regenerator material member 60. For example, a width in the radial direction and/or a height in the axial direction of the outer rim portion 60a and/or the inner rim portion 60b may be smaller than 1/10, 1/30, 1/50, or 1/100 of a width (for example, diameter) in the radial direction of the regenerator material member 60. The width in the radial direction and/or the height in the axial direction of the outer rim portion 60a and/or the inner rim portion 60b may be less than 1 mm, 0.5 mm, or 0.1 mm.

A surface of the holder 62 which comes into contact with the regenerator material member 60 has a curved shape corresponding to the curved shape of the regenerator material member 60 so as to receive the regenerator material member 60. Each of the pair of holders 62 includes an outer edge portion 63a which has a curved shape corresponding to the outer rim portion 60a, and an inner edge portion 63b which has a curved shaped corresponding to the inner rim portion 60b. In addition, each of the pair of holders 62 has a center portion 63c which is formed in a flat shape corresponding to the center flat portion 60c. The holder 62 of the low temperature portion and the holder 62 of the normal temperature portion have shapes complementary to each other. Accordingly, the holder 62 of the low temperature portion can receive the holder 62 of the normal temperature portion.

The regenerator material member 60 has a slightly larger size than a size of a sectional area of the accommodation space in the regenerator material vessel 52 on the plane perpendicular to the axial direction. A length in the radial direction of the regenerator material member 60 is slightly longer than a length in the radial direction of the annular region or the doughnut-shaped region in the section of the regenerator material vessel 52. Accordingly, in assembly work of the regenerator 38, when the regenerator material members 60 are incorporated into the regenerator material vessel 52, the outer circumferences and the inner circumferences of the regenerator material members 60 are curved by contact with the regenerator material vessel 52, and the outer rim portions 60a and the inner rim portions 60b are formed. Since the regenerator material members 60 are laminated, and compressed and held by the holders 62, the curved shapes formed on the outer rim portions 60a and the inner rim portions 60b are held. Accordingly, it is possible to effectively remove both the inner gap and the outer gap generated in the annular regenerator 38.

Alternatively, the outer rim portions 60a and the inner rim portions 60b may be formed in advance. Before the assembly work of the regenerator 38, the outer rim portions 60a and the inner rim portions 60b may be formed by rolling the wire mesh members.

Accordingly, in the regenerator 38, it is possible to remove the gap generated between the regenerator material vessel 52 and the regenerator material laminated body 58. Therefore, it is possible to prevent performance of the regenerator 38 from decreasing due to the flow of the working gas into the gap.

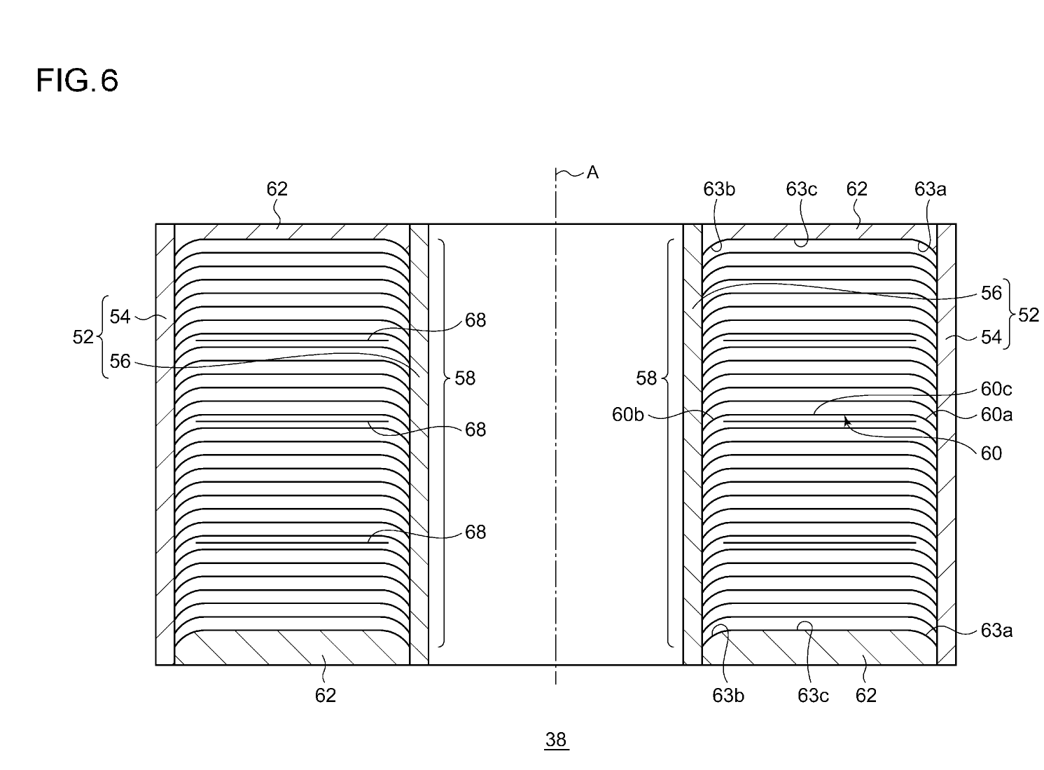

FIG. 6 is a sectional view schematically showing the regenerator 38 according to a second embodiment of the present invention. In the second embodiment, the lamination structure of the regenerator materials is different from that of the first embodiment. The others of the second embodiment are similar to the first embodiment. In descriptions below, in order to avoid redundant descriptions, descriptions with respect to the similar portions are appropriately omitted.

The regenerator material laminated body 58 includes at least one second regenerator material member 68 which is laminated in the axial direction along with the first regenerator material members 60. The second regenerator material member 68 is alternately laminated with one or more (for example, ten or more) first regenerator material members 60. The plurality of second regenerator material members 68 may be alternately laminated with one or more first regenerator material members 60.

The second regenerator material member 68 is disposed between the inner rim portion 60b and the outer rim portion 60a of the first regenerator material member 60. The second regenerator material member 68 has the shape corresponding to the center flat portion 60c of the first regenerator material member 60. Accordingly, the second regenerator material member 68 extends along the plane perpendicular to the axial direction, and does not include a rim portion. Since the second regenerator material member 68 does not include the rim portion, the diameter dimension of the second regenerator material member 68 is smaller than that of the first regenerator material member 60.

It is possible to press the center flat portion 60c of the first regenerator material member 60 by the second regenerator material member 68. Since the first regenerator material members 60 and the second regenerator material member 68 are alternately laminated with each other, it is possible to laminate the plurality of first regenerator material members 60 in parallel to the plane perpendicular to the axial direction.

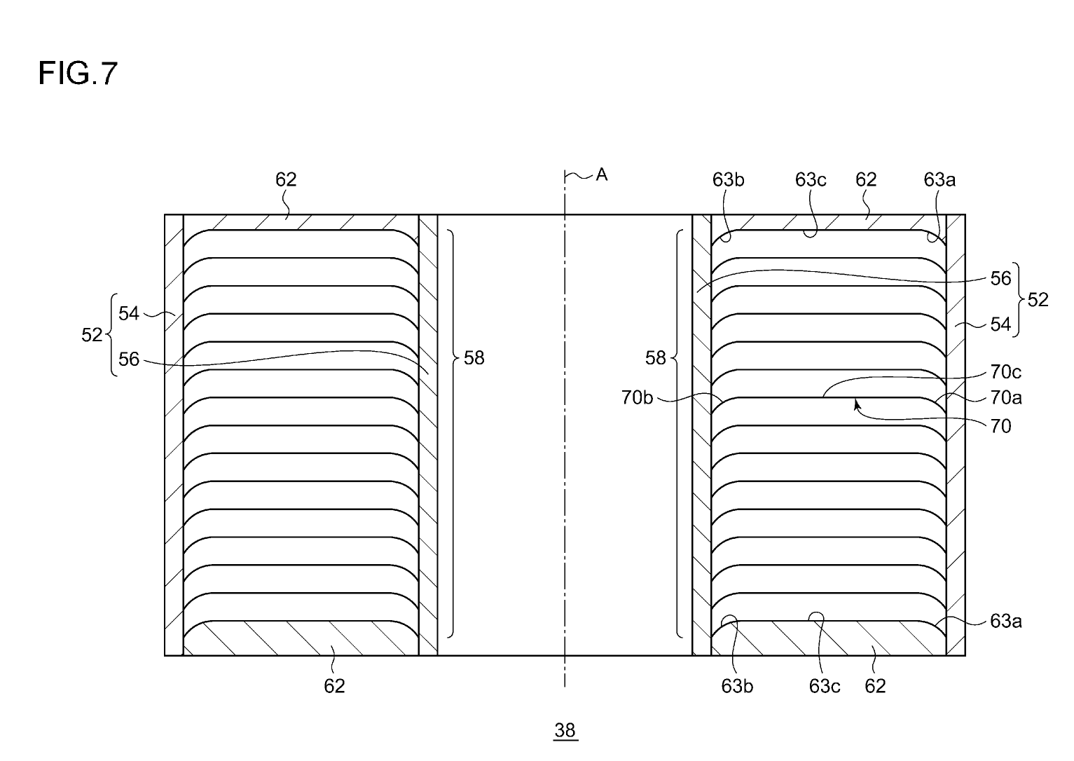

FIG. 7 is a sectional view schematically showing the regenerator 38 according to a third embodiment of the present invention. In the third embodiment, the regenerator material is different from that of the first embodiment. The others of the third embodiment are similar to the first embodiment. In descriptions below, in order to avoid redundant descriptions, descriptions with respect to the similar portions are appropriately omitted.

In the third embodiment, the regenerator material member is a felt-shaped sintered metal body 70. Accordingly, the regenerator material laminated body 58 is formed of a plurality of sintered metal bodies 70 which are laminated in the axial direction. Each of the sintered metal bodies 70 extends along the plane perpendicular to the axial direction. The sintered metal body 70 has an annular shape or a doughnut shape. A thickness in the axial direction of the sintered metal body 70 is thicker than the thickness in the axial direction of the regenerator material member 60 in the first embodiment.

Similarly to the regenerator material member 60 in the embedment, the felt-shaped sintered metal body 70 includes an outer rim portion 70a, an inner rim portion 70b, and a center flat portion 70c. The center flat portion 70c is annular region which occupies most of the sintered metal body 70, and extends along a plane perpendicular to the axial direction. The outer rim portion 70a extends toward the outside in the radial direction from the center flat portion 70c, and forms a portion of the sintered metal body 70. The inner rim portion 70b extends toward the inside in the radial direction from the center flat portion 70c, and forms a portion of the sintered metal body 70.

The pair of holders 62 is provided on both ends of the regenerator material laminated body 58 in the axial direction. The surface of the holder 62 which comes into contact with the sintered metal body 70 has a curved shape corresponding to the curved shape of the sintered metal body 70 so as to receive the sintered metal body 70.

In order to remove a gap generated between the vessel inner cylinder 56 and the regenerator material laminated body 58, the sintered metal body 70 has a slightly larger size than the size of the sectional area of the accommodation space in the regenerator material vessel 52 on the plane perpendicular to the axial direction. In assembly work of the regenerator 38, when the sintered metal bodies 70 are incorporated into the regenerator material vessel 52, the outer circumferences and the inner circumferences of the sintered metal bodies 70 are curved, and the outer rim portions 70a and the inner rim portions 70b are formed. Alternatively, the outer rim portions 70a and the inner rim portions 70b may be formed in advance.

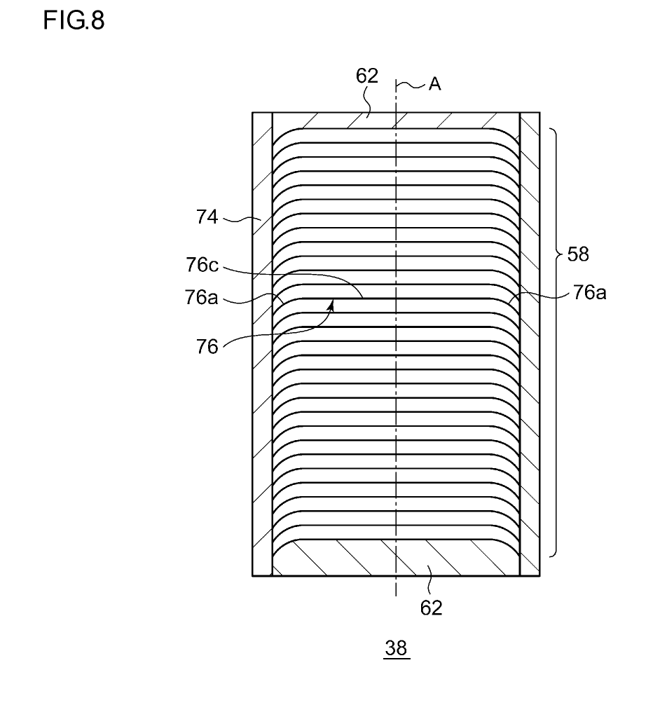

FIG. 8 is a sectional view schematically showing the regenerator 38 according to a fourth embodiment of the present invention. In the fourth embodiment, the regenerator material vessel is different from that of the first embodiment. The others of the fourth embodiment are similar to the first embodiment. In descriptions below, in order to avoid redundant descriptions, descriptions with respect to the similar portions are appropriately omitted.

The regenerator material laminated body 58 is accommodated in a displacer 74 serving as the regenerator material vessel. A cylindrical accommodation space is formed in the inner portion of the displacer 74. A plurality of regenerator material members 76 are laminated in the axial direction of the displacer 74 in the accommodation space. Each of the regenerator material members 76 is a circular wire mesh member or a felt-shaped sintered metal body. The regenerator material member 76 is formed in a tray shape or a flat dish shape. The regenerator material member 76 includes an outer rim portion 76a and a center flat portion 76c. The outer rim portion 76a extends from the center flat portion 76c in a direction (for example, axial direction) other than the direction of the plane perpendicular to the axial direction. The outer rim portion 76a comes into contact with the displacer 74. Accordingly, a gap which is generated between the displacer 74 and the regenerator material laminated body 58 is filled with the outer rim portions 76a.

Similarly to the second embodiment, the regenerator material laminated body 58 may include at least one second regenerator material member which is alternately laminated with one or more first regenerator material members 76 in the axial direction. The second regenerator material member may has a shape which is disposed inside the outer rim portion 76a and corresponds to the center flat portion 76c.

The regenerator 38 according to the fourth embodiment may be used in a GM cryocooler, a Stirling cryocooler, or other regenerator-type cryocoolers.

Embodiments of the present invention may be described as follows.

1. A regenerator including:

an axially extending regenerator-element container; and

a regenerator-element laminated structure accommodated in the regenerator-element container; wherein

the regenerator-element laminated structure includes a plurality of first regenerator-element members axially stacked in layers, and each extending along a plane perpendicular to the axis of regenerator extension, and

the plurality of first regenerator-element members each include a rim portion extending in a direction not lying in said plane, such as to fill a gap between the regenerator-element container and the regenerator-element laminated structure.

2. The regenerator according to 1, wherein the first regenerator-element members include wire mesh components, and a part of each wire mesh component forms the rim portion of the respective first regenerator element member.

3. The regenerator according to 1, wherein the first regenerator-element members include felt-like sintered metal structures, and a part of each felt-like sintered metal structure forms the rim portion of the respective first regenerator element member.

4. The regenerator according to any one of 1 to 3, wherein the regenerator-element laminated structure includes the plurality of first regenerator-element members axially stacked together with at least one second regenerator-element member, and the second regenerator element member is disposed inward of the rim portions.

5. The regenerator according to any one of 1 to 3, wherein the regenerator-element container includes axially extending container inner and outer cylinders, and the regenerator-element laminated structure is accommodated in between the container inner and outer cylinders, and each of the plurality of first regenerator-element members includes an inner rim portion extending in a direction not lying in said plane, and an outer rim portion extending in a direction not lying in said plane such as to fill an inner gap between the container inner cylinder and the regenerator-element laminated structure, and such as to fill an outer gap between the container outer cylinder and the regenerator-element laminated structure.

6. The regenerator according to 5, wherein the regenerator-element laminated structure further includes the plurality of first regenerator-element members and axially stacked together with at least one second regenerator-element member, and the second regenerator-element member is disposed in between the first regenerator-element member inner and outer rim portions.

7. The regenerator according to any one of 1 to 6, further including a pair of holders clamping both of axial ends of the regenerator-element laminated structure such as to axially compressively retain the regenerator-element laminated structure, wherein the pair of holders each include an edge portion of form corresponding to that of the rim portions.

8. A cryocooler including the regenerator according to any one of 1 to 7.

9. A Stirling cryocooler, including:

an axially extending displacer; and

a regenerator arranged surrounding the displacer such as to guide axially reciprocating travel of the displacer; wherein

the regenerator includes a container inner cylinder extending axially and guiding the reciprocating travel of the displacer, a container outer cylinder extending axially and forming an accommodation space between the container inner and outer cylinders, and a regenerator-element laminated structure accommodated in the accommodation space;

the regenerator-element laminated structure include a plurality of first regenerator-element members axially stacked in layers, and each extending along a plane perpendicular to the axis of regenerator extension; and

the plurality of first regenerator-element members each include an inner rim portion extending in a direction not lying in said plane, and an outer rim portion extending in a direction not lying in said plane, such as to fill an inner gap between the container inner cylinder and the regenerator-element laminated structure, and such as to fill an outer gap between the container outer cylinder and the regenerator-element laminated structure.

10. The Stirling cryocooler according to 9, wherein the first regenerator-element members include wire mesh components, and parts of each wire mesh component form the inner and outer rim portions of the respective first regenerator element member.

11. The Stirling cryocooler according to 9, wherein the first regenerator-element members include felt-like sintered metal structures, and parts of each felt-like sintered metal structure form the inner and outer rim portions of the respective first regenerator element member.

12. The Stirling cryocooler according to any one of 9 to 11, wherein the regenerator-element laminated structure includes the plurality of first regenerator-element members axially stacked together with at least one second regenerator-element member, and the second regenerator element member is disposed inward of the rim portions.

13. The Stirling cryocooler according to any one of 9 to 12, further including a pair of holders clamping both of axial ends of the regenerator-element laminated structure such as to axially compressively retain the regenerator-element laminated structure, wherein the pair of holders each include an inner edge portion and an outer edge portion of form corresponding to that of the inner and outer rim portions.

Hereinbefore, certain embodiments of the invention are described. It should be understood that the invention is not limited to the above-described embodiment, but may be modified into various forms on the basis of the spirit of the invention. Additionally, the modifications are included in the scope of the invention.

What is claimed is:

1. A regenerator comprising:
an axially extending regenerator-element container; and
a regenerator-element laminated structure accommodated in the regenerator-element container; wherein
the regenerator-element laminated structure comprises a plurality of first regenerator-element members axially stacked in layers, and each extending along a plane perpendicular to the axis of regenerator extension, and
the plurality of first regenerator-element members each comprise a rim portion extending in a direction not lying in said plane, such as to fill a gap between the regenerator-element container and the regenerator-element laminated structure.

2. The regenerator according to claim 1, wherein the first regenerator-element members comprise wire mesh components, and the rim portions constitute part of the wire mesh components.

3. The regenerator according to claim 1, wherein the first regenerator-element members comprise felt-like sintered metal structures, and the rim portions constitute part of the sintered metal structures.

4. The regenerator according to claim 1, wherein:
the regenerator-element laminated structure comprises the plurality of first regenerator-element members axially stacked together with at least one second regenerator-element member; and
the second regenerator element member is disposed inward of the rim portions.

5. The regenerator according to claim 1, wherein:
the regenerator-element container includes axially extending container inner and outer cylinders, and the regenerator-element laminated structure is accommodated in between the container inner and outer cylinders; and
each of the plurality of first regenerator-element members includes an inner rim portion extending in a direction not lying in said plane, and an outer rim portion extending in a direction not lying in said plane such as to fill an inner gap between the container inner cylinder and the regenerator-element laminated structure, and such as to fill an outer gap between the container outer cylinder and the regenerator-element laminated structure.

6. The regenerator according to claim 5, wherein:
the regenerator-element laminated structure further comprises the plurality of first regenerator-element members and axially stacked together with at least one second regenerator-element member; and
the second regenerator-element member is disposed in between the first regenerator-element member inner and outer rim portions.

7. The regenerator according to claim 1, further comprising:
a pair of holders clamping both of axial ends of the regenerator-element laminated structure such as to axially compressively retain the regenerator-element laminated structure; wherein
the pair of holders each comprise an edge portion of form corresponding to that of the rim portions.

8. A Stirling cryocooler, comprising:
an axially extending displacer; and
a regenerator arranged surrounding the displacer such as to guide axially reciprocating travel of the displacer; wherein
the regenerator comprises a container inner cylinder extending axially and guiding the reciprocating travel of the displacer, a container outer cylinder extending axially and forming an accommodation space between the container inner and outer cylinders, and a regenerator-element laminated structure accommodated in the accommodation space;
the regenerator-element laminated structure comprise a plurality of first regenerator-element members axially stacked in layers, and each extending along a plane perpendicular to the axis of regenerator extension; and
the plurality of first regenerator-element members each comprise an inner rim portion extending in a direction not lying in said plane, and an outer rim portion extending in a direction not lying in said plane, such as to fill an inner gap between the container inner cylinder and the regenerator-element laminated structure, and such as to fill an outer gap between the container outer cylinder and the regenerator-element laminated structure.
